(19) United States
(12) Patent Application Publication
(10) Pub. No.: US 2024/0121679 A1
(43) Pub. Date: Apr. 11, 2024

(54) Selecting Handover Target Based on Configurable Metrics

(71) Applicant: Dell Products L.P., Round Rock, TX (US)

(72) Inventors: Vikas Arora, Ottawa (CA); Ravi Sharma, Santa Clara, CA (US)

(21) Appl. No.: 18/045,555

(22) Filed: Oct. 11, 2022

(51) Int. Cl. H04W 36/00; H04W 48/20

(52) U.S. Cl. CPC H04W 36/00837; H04W 36/0058; H04W 36/00835; H04W 48/20

(57) ABSTRACT

Improved techniques for selecting a handover target cell are described herein, for example in connection with a 5G disaggregated radio network. For example, in addition to evaluating signal quality metrics that are reported by the user equipment subject to the handover, the disclosed techniques can also evaluate additional metrics. For example, a load associated with potential target cells can be considered as neighbor load can cause handover issues. As another example, a history of success rates associated with a handover to the target cell and/or from the serving cell can be considered as well since handover failures can sometimes result due to issues that can be surfaced by the success rate history.

### BACKGROUND

In wireless or cellular networks, user equipment (UEs), or user devices are provided network access by access point devices. For networks that support mobility, it is common for a user equipment (UE) to undergo a handover procedure, which transfers service from a serving access point to a neighbor or target access point device. Such can occur for a variety of different reasons, such as due to the user equipment moving away from the serving access point device, due to issues involving the serving access point device or any other reason.

In modern 5G radio networks, handover protocols are described in standards documents. These documents allow for several metrics to be considered when determining a target for a handover operation. For example, in a modern 5G disaggregated radio network, a control unit control plane (CU-CP) device typically runs a target cell selection process to decide which cell a UE is to be transferred to as part of an ongoing mobility procedure. This 5G defined target cell selection process examines public land mobile network (PLMN) data and type allocation code (TAC) data to determine if any cells should be restricted. The 5G defined target cell selection process further examines blacklist data to determine if any other cells should be restricted. The 5G defined target cell selection process also examines neighbor cell list (NCL) data or self-organizing network (SON) data, which can be used to give lower priority to cells that are not part of the NCL.

Generally speaking, apart from restricting particular cells or giving non-NCL cells lower priority, the target cell selection process defined by 5G standards essentially operates to merely prioritize handover target cells based on reported signal quality metrics, such as signal strength.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram that illustrates an example logical network 100 architecture of a 5G disaggregated network in accordance with some example embodiments of this disclosure;

FIG. 2 depicts a schematic block diagram 200 that illustrates an example logical architecture of a 5G disaggregated node in accordance with some example embodiments of this disclosure;

FIG. 3 depicts a schematic block diagram 300 illustrating an example network device 302 that can provide improved techniques for handover target selection in accordance with some example embodiments of this disclosure;

FIG. 4 depicts a block diagram 400, illustrating various example signal metric values of signal data 306 in accordance with some example embodiments of this disclosure;

FIG. 5 depicts a block diagram 500, illustrating various examples of multiple scores combined to determine a given handover score 322 in accordance with some example embodiments of this disclosure;

FIG. 6 illustrates a schematic block diagram 600 depicting techniques for determining success rate score 504 in accordance with some example embodiments of this disclosure;

FIG. 7 illustrates a schematic block diagram 700 depicting techniques for determining neighbor load score 506 in accordance with some example embodiments of this disclosure;

FIG. 8 illustrates a schematic block diagram 800 depicting techniques for determining neighbor handover score 322 in accordance with some example embodiments of this disclosure;

FIG. 9 illustrates an example method that can select a handover target cell based on a neighbor load score and/or a historic handover success rate score in accordance with some example embodiments of this disclosure;

FIG. 10 illustrates an example method that can provide for additional elements in connection with selecting a handover target cell based on a neighbor load score and/or a historic handover success rate score in accordance with some example embodiments of this disclosure;

FIG. 11 illustrates an example block diagram of a computer operable to execute example embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

The present application relates generally to improved techniques for handover target cell selection. As noted in the background section, apart from restricting particular cells or giving non-NCL cells lower priority, the target cell selection process defined by 5G standards essentially operates to merely prioritize handover target cells based on reported signal quality metrics, such as signal strength. While signal quality is a useful metric in determining a handover target, other metrics, including metrics not currently considered in other systems, can be useful as well. For example, consider the case in which multiple neighbor cells are measured by a user equipment (UE) subject to a handover operation to have similar signal quality metrics. In that case, merely selecting one cell target over the other due to marginal differences in reported signal quality may not lead to the optimal outcome.

Rather, considering additional criteria may lead to improved handover performance and outcomes. For example, the disclosed subject matter considers that, in addition to various signal quality metrics, handover target cell selection can be further based on other reliable indicators such as target cell load, target cell historical handover success, or other reliable indicators.

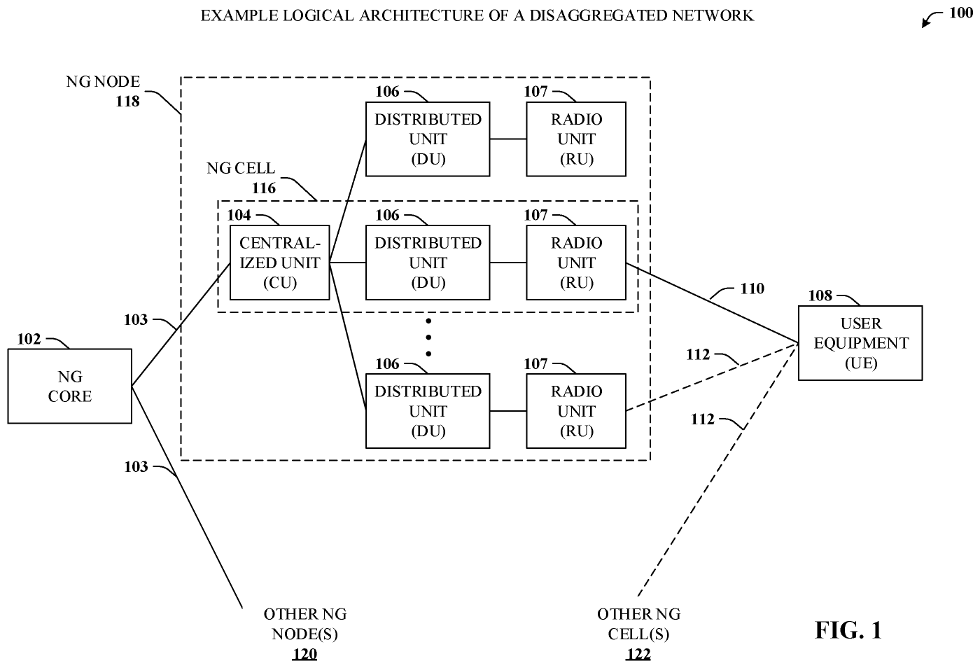

In order to better understand the subject matter detailed herein, it can be instructive to consider an example disaggregated 5G network architecture. FIG. 1 depicts a schematic block diagram that illustrates an example logical network 100 architecture of a 5G disaggregated network in accordance with some example embodiments of this disclosure. In this example, the network 100 comprises next generation (NG) core 102 configured to communicate via backhaul 103 with one or more nodes, illustrated here as NG node 118 shown in more detail and one or more other NG node(s) 120. Specifically, within NG node 118, NG core 102 communicates with one or more centralized units (CUs) 104. Typically, backhaul 103 transports data according to Internet protocol (IP).

CU 104 can communicate via a midhaul interface with one or more distributed units (DUs) 106. The midhaul interface can operate according to IP in order to communicate with one or more DUs 106. A given DU 106 can communicate via a fronthaul interface with one or more radio units (RUs) 107, which typically represent access point devices to which user equipment 108 attaches for network service. In this example, UE 108 is attached to a RU 107 via link 110. Links 112 show potential handover targets, which can be a different cell/RU 107 within the same NG node 118 or other NG cell(s) 122 in other NG node(s) 120. In some embodiments, logically speaking, NG cell 116 can be considered a combination of CU 104 and a respective DU 106 and/or respective RUs 107, as illustrated here. In other embodiments, NG cell 116 can be used interchangeably with RU 107 or DU 106. In some embodiments, RU 107 and DU 106 can be the same physical or logical device.

In some embodiments, any of NG core 102, CU 104, DU 106, RU 107 can be virtualized and operate, respectively, as a virtual elements.

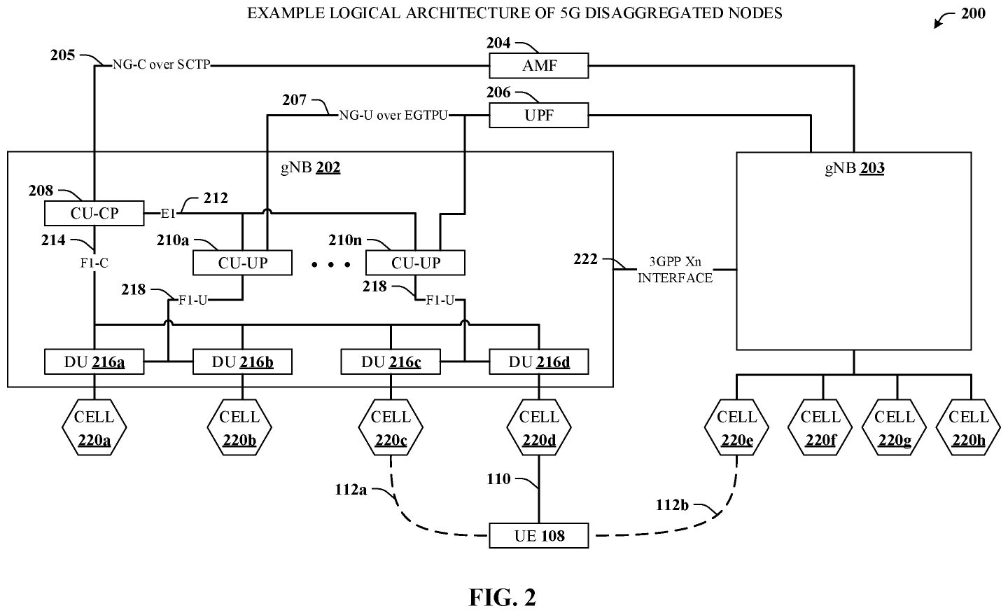

FIG. 2 depicts a schematic block diagram 200 that illustrates an example logical architecture of a 5G disaggregated node in accordance with some example embodiments of this disclosure. This example illustrates next generation NodeB (gNB) 202 in detail as well gNB 203. gNB 202 can be substantially similar and represent a more detailed representation of NG node 118 of FIG. 1 and gNB 203 can be substantially similar to other NG node(s) 120 that is a potential neighbor of gNB 202.

Access and mobility function (AMF) 204 can communicate with gNB 202, gNB 203, and so on. For example, AMF 204 can communicate with one or more centralized unit control plane (CU-CP) 208 via link 205 that operates according to NG-C over stream control transmission protocol (SCTP). AMF 204 typically receives connection and session related information from UE 108. Likewise, user plane function (UPF) 206 can also communicate with gNB 202, gNB 203, and so on. For instance, UPF 206 can communicate with one or more centralized unit user planes (CU-UPs) 210, illustrated here as CU-UP 210a-210n, where n is any whole number, via link 207, such as a NG-U over EGTPU. UPF 206 can provide an interconnect between mobile infrastructure and data networks.

In a 5G radio network, gNB 202, 203 are primarily responsible controlling the mobility of UE 108 that is under its coverage area. For instance, gNB 202 can set trigger conditions that UE 108 will follow for performing signal quality measurements of neighbor cells and can also determine selection of the target cell. Hence, gNB 202 can configure UE108 (e.g., using 3GPP defined RRC protocol) to report measurements of the neighbor cells containing the signal quality values. There are different trigger events (e.g., 3GPP ref 38.331) defined by gNB 202 that defines when a UE generates said measurement reports.

Referring specifically to CU-CP 208, this element hosts radio resource control (RRC) and the control plane portion of the packet data convergence protocol (PDCP). CU-CP 208 communicates with one or more CU-UPs 210 via link 212 representative of an E1 interface. CU-CP 208 communicates with one or more distributed units (DUs) 216 via link 214 representative of a F1-C interface. In this example, four DUs 216 are illustrated, namely DU 216a, DU 216b, DU 216c, and DU 216d, but it is appreciated that any suitable number of DUs 216 can exist.

As illustrated, each DU 216 can be associated with a given cell 220, labeled as cell 220a, cell 220b, cell 220c, and cell 220d. In some embodiments, cells 220 can be representative of radio units such as RU 107 indicted in FIG. 2. In this example, cell 220d is the serving cell as reflected by link 110. Links 112 illustrate potential handover targets, where link 112a represents an intra-gNB handover (e.g., target cell is in the same gNB node) whereas link 112b represents an inter-gNB handover (e.g., target cell is in a different gNB node). As shown, individual gNBs can communicate over link 222 representing a 3GPP Xn interface.

In a disaggregated gNB 202, as illustrated here, where functions are separated between, e.g., CU-CP 208, CU-UP 210, DUs 216, and/or radio units (e.g., RU 107), the handover control determination is hosted by CU-CP 208. As mentioned, one of the main criteria that a given CU-CP uses to select the target cell is based on the measurement reports received from UE 108. Additionally, other factors that are considered are generally configured in CU-CP 208 and/or gNB 202 as part of handover policy configurations or adjacencies.

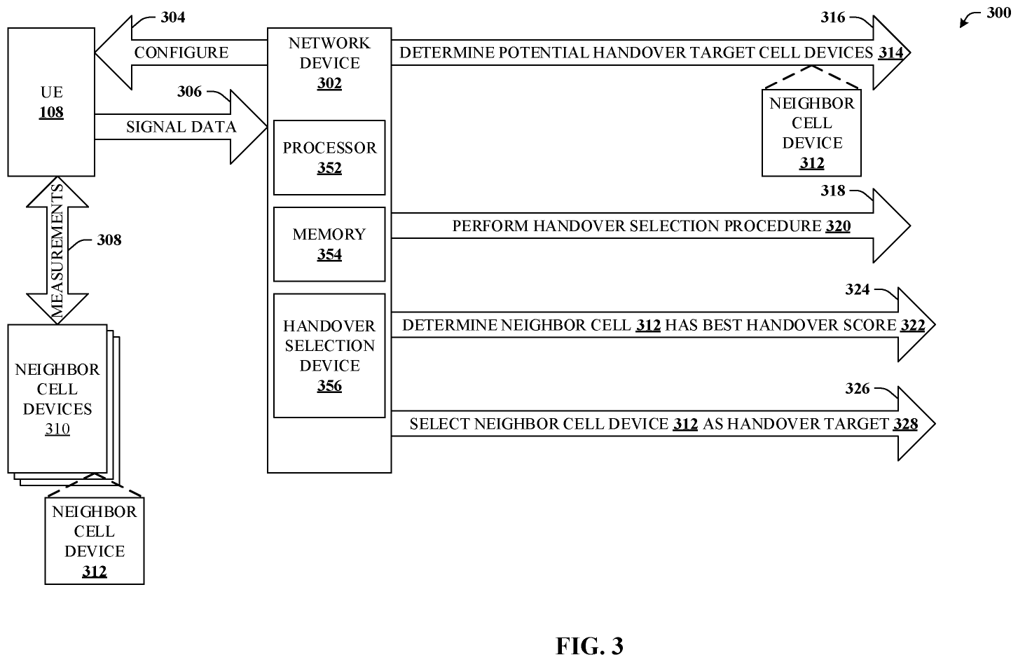

However, previous techniques for handover target cell selection fail to consider certain factors that are further detailed in connection with FIG. 3 and other FIGS herein. With respect to the disclosed subject matter, FIG. 3 introduces new techniques and/or the concept of considering specific factors not otherwise considered in handover target cell selection. As CU-CP 208 typically handles handover procedures and policies, CU-CP 208 can be a representative example of network device 302 of FIG. 3.

### Example Systems

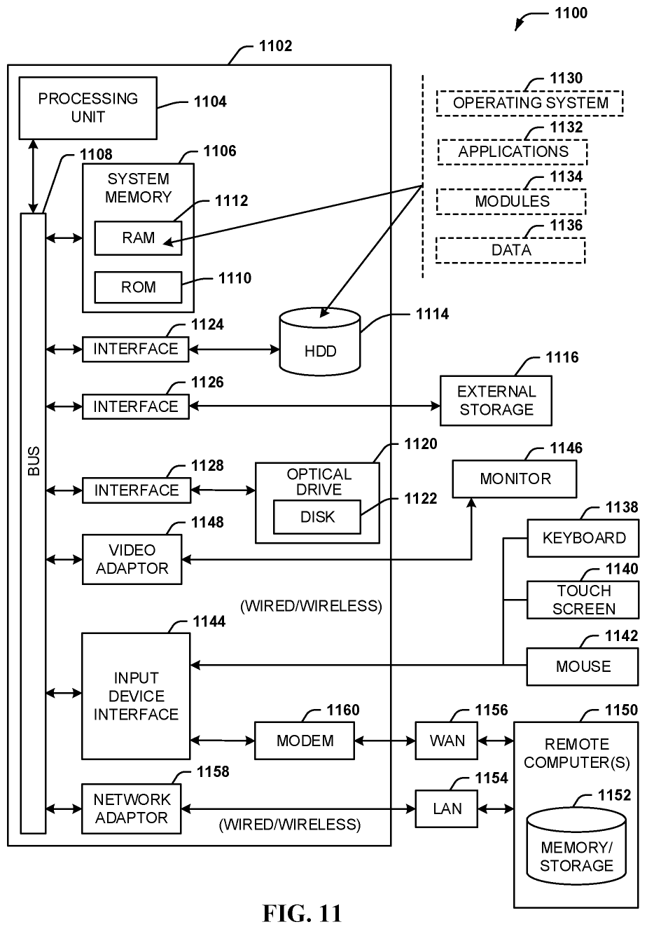

Referring now to FIG. 3, a schematic block diagram 300 is depicted illustrating an example network device 302 that can provide improved techniques for handover target selection in accordance with some example embodiments of this disclosure. As discussed above, one representative example of network device 302 can be CU-CP 208. Network device 302 can comprise a processor 352 that can be specifically configured for handover selection operations such as in accordance with handover selection device 356. Network device 302 can also comprise memory 354 that stores executable instructions that, when executed by processor 352, can facilitate performance of operations. Processor 352 can be a hardware processor having structural elements known to exist in connection with processing units or circuits, with various operations of processor 352 being represented by functional elements shown in the drawings herein that can require special-purpose instructions, for example, stored in memory 354 and/or handover selection device 356, which can be a component or circuit. Along with these special-purpose instructions, processor 352 and/or network device 302 can be a special-purpose device. One non-limiting example of memory 354 and processor 352 can be found with reference to FIG. 11. It is to be appreciated that network device 302 or computer 1102 can represent a host device, a client device, or other device that can be used in connection with implementing one or more of the systems, devices, or components shown and described in connection with FIG. 3 and other figures disclosed herein.

As depicted by reference numeral 304, Network device 302 can configure UE 108 to report signal data 306. Signal data 306 can be representative of signal measurements 308 comprising respective signal metric values associated with signaling with a group of neighbor cell devices 310. Generally, UE 108 can be served by a serving cell device (e.g., network device 302 or a node or gNB comprising network device 302) and can have a group of neighbor cell devices 310 that can be candidates for handovers. Typically, handovers are triggered by a defined event (e.g., mobility, poor signal quality, . . . ) and this triggering can be configured by network device 302.

The group of neighbor cell devices 310 can comprise neighbor cell device 312. Neighbor cell device 312, as used herein, represents the particular cell that is ultimately selected as the handover target. Additional discussion is provided below detailing how neighbor cell device 312 is selected.

Continuing the description of block diagram 300, network device 302 can receive signal data 306. For example, when the trigger condition triggers and UE 108 performs signal measurements 308, that data can be reported to network device 302. In response to receiving signal data 306 from UE 108, network device 302 can determine potential handover target cell devices 314, which is illustrated by reference numeral 316. Potential handover target cell devices can be selected from among neighbor cell devices 310 and can therefore be a subset of neighbor cell devices 310, comprising neighbor cell device 312. Determination 316 can be accomplished based on various signal metric values obtained from signal measurements 308. For instance, only those cell devices having a signal metric value that is above a defined threshold may be included in the subset of potential handover target cell devices 314.

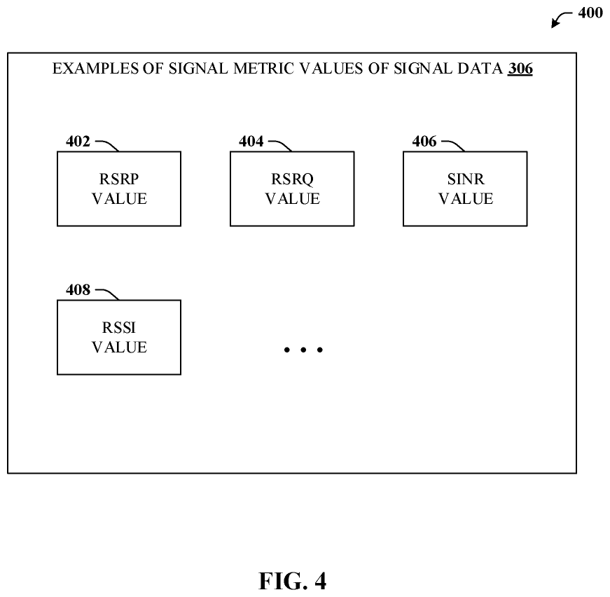

By way of illustration, while still referring to FIG. 3, but turning now as well to FIG. 4, a block diagram 400, illustrating various example signal metric values of signal data 306, is depicted in accordance with some example embodiments of this disclosure. It is appreciated that these example signal metrics are intended to be non-limiting as other signal strength or signal quality signal metrics are envisioned. As one example, a signal metric value can be a reference signal received power (RSRP) value 402. As another example, a signal metric value can be a reference signal received quality (RSRQ) value 404. Yet another example of a signal metric value can be a signal to interference plus noise ratio (SINR) value 406. Still another example of a signal metric value can be any other received signal strength indicator (RSSI) value 406.

Still referring to FIG. 3, as illustrated at reference numeral 318, network device 302 can perform handover selection procedure 320. Handover selection procedure 320 can select a target device 328 for a handover operation that transfers UE 108 service from a serving cell device to the target device 328. The target cell device 328 can be selected from among neighbor cell devices 310 or potential handover target cell devices 314.

In order to select target device 328, handover selection procedure 320 can determine which cell device from among potential handover target cell devices 314 (or the superset, neighbor cell devices 310) has the best handover score 322, which is illustrated at reference numeral 324. A respective handover score 322 can be determined for each respective cell device of potential handover target cell devices 314 and those respective scores can be compared to identify the highest handover score 322.

In this example, neighbor cell device 312 has the highest or best handover score 322. Thus, as illustrated at reference numeral 326, neighbor cell device 312 is selected as handover target 328.

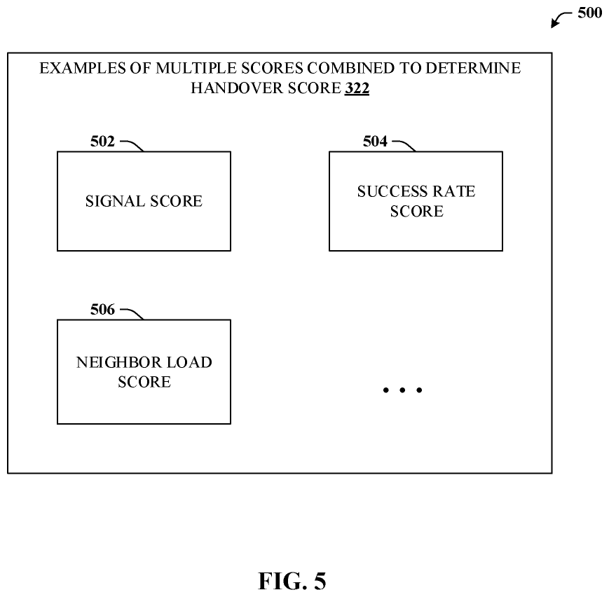

Handover score 322 can be a combination of multiple different scoring metrics, examples of which are further detailed in connection with FIG. 5.

Referring now to FIG. 5, a block diagram 500, illustrating various examples of multiple scores combined to determine a given handover score 322, is depicted in accordance with some example embodiments of this disclosure. For example, the multiple scores can comprise a signal score 502, a success rate score 504, a neighbor load score 506, and any other suitable score. Signal score 502 can be determined as a function of the signal metric value(s) received as part of signal data. Signal score 502 is a useful metric and one that can be derived from information that many systems use for handover target cell selection, but signal score 502 is not the only potentially useful metric.

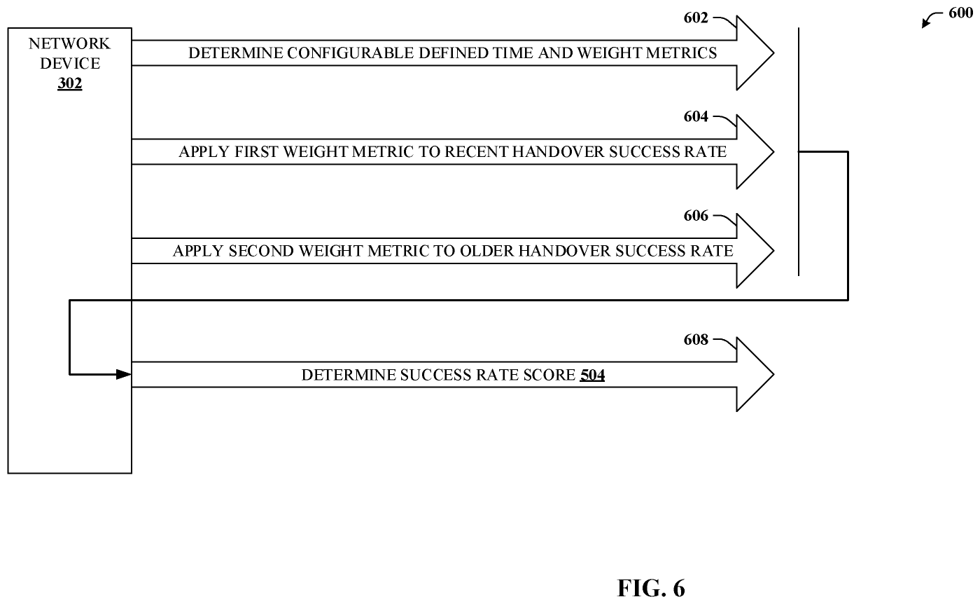

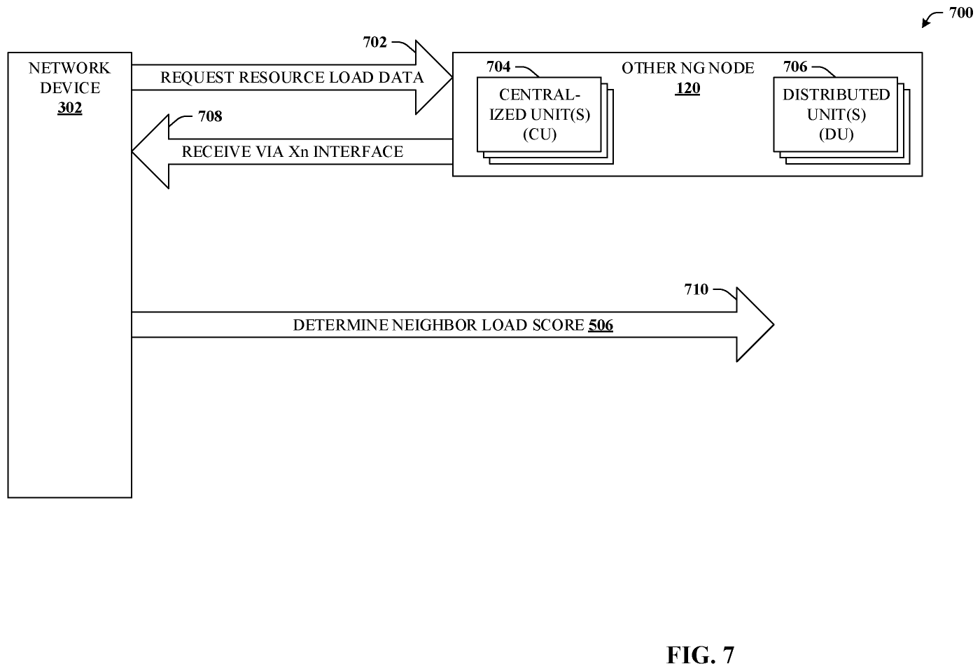

In particular, other systems fail to contemplate use of success rate score 504 and neighbor load score 506 or associated information when selecting a handover target cell. Success rate score 504 can be a metric indicative of past success rates of handover to target cell 328. Additional detail relating to success rate score 506 is detailed in connection with FIG. 6. Neighbor load score 506 can be a metric indicative of resource load data of a neighbor node device (or a particular component device of neighbor node) that comprises target cell device 328. Additional detail relating to neighbor load score can be found with reference to FIG. 7.

Turning now to FIG. 6, a schematic block diagram 600 is depicted illustrating techniques for determining success rate score 504 in accordance with some example embodiments of this disclosure. Initially, it is noted that in some embodiments, success rate score 504 can reflect an overall success rate of previous handover attempts in which neighbor cell device 312 was the handover target. In some embodiments, success rate score 504 can reflect only those previous handover attempts in which neighbor cell device 312 was the handover target from a particular serving cell device. Hence, in the former case, success rate score 504 is specific to handover target cell 328, while in the latter case, success rate score 504 is specific to handover target cell 328 and the serving cell device.

Previous handover success rates can be a useful evaluation criterion because sometimes, due to configuration or another reason, handovers are unsuccessful even when signal quality metrics would indicate otherwise. Sometimes, again due to configuration or another reason, handover attempts fail when handing over to a particular cell, from a particular cell, or both. Any such problem may eventually be solved and therefore previous poor handover success rates can be improved over time.

Hence, success rates can be separated temporally into a recent category and an older category. For example, a defined time can be determined such that handover successes or failures that occurred prior to the defined time can be classified into the older category, whereas those occurring after the defined time can be classified into the recent category. Thus, an operator is free to apply configurable weight metrics to be applied to one or both of the recent category or the older category to put either more or less emphasis on one or the other.

At reference numeral 602, network device 302 can determine the defined time and the weight metrics. It is appreciated that both of these elements can be configurable according to a particular policy, a particular implementation arrangement, or otherwise. In some embodiments, the defined time and the weight metrics can be determined according to machine learning techniques.

As one example implementation, consider a coefficient C, which is between zero and one. C can represent a first weight metric and 1-C can represent a second weight metric, both of which can be determined at determination 602. At reference numeral 604, the first weight metric can be applied to a recent handover success rate. At reference numeral 606, the second weight metric can be applied to an older handover success rate.

Suppose X is set to 0.90, as illustrated in Table I below. In that case, recent handover success rates are heavily weighted (e.g., 90% contribution), whereas older handover success rates are lightly weighted (e.g., 10% contribution).

TABLE I

| | Apply Weight | Success Rate |
|---|---|---|
| | Metrics | Score (SR) |
| Older Success Rate (SR_{O}): | (SR_{O})*(0.10) | (SR_{O})*(0.10) + |
| Recent Success Rate (SR_{O}): | (SR_{R})*(0.90) | (SR_{R})*(0.90) = SR |

These example weight metrics may be implemented in the case of a node being recently reconfigured to fix poor handover success rates, for example. Thus, the defined time can be set to the time when the update or reconfiguration occurred (or due to another event or time factor). Recent handover success rates are more heavily weighted because, after the update or reconfiguration, older success rates may not be particularly indicative of future performance.

In a different example, X may be set to 0.5 so that recent and older handover success rates are equally weighted. In some embodiments, C may be set to 1 or 0 to entirely remove one or the other of the older success rate or the recent success rate. Regardless of the particular values of the first and second weight metric, either one or both can contribute to the ultimate success rate score 504 (e.g., SR in Table I), which can be determined at reference numeral 608. A high success rate score 504 can serve to prioritize selection of the associated cell, whereas associated cells with a lower success rate score 504 can be given lower priority or ranking.

With reference now to FIG. 7, a schematic block diagram 700 is depicted illustrating techniques for determining neighbor load score 506 in accordance with some example embodiments of this disclosure. As mentioned, neighbor load score 506 can be considered in connection with handover selection procedure 320. Neighbor load score 506 can be indicative of some resource load data of a neighbor node device (e.g., other NG nod 120 and/or eNB 203), or component devices thereof. For example while a given gNB node may initiate a handover to a target node or cell, such can ultimately return an error to indicate an overload. This process extends the handover phase, which can impact the quality of experience for a user.

Such can be mitigated by employing neighbor load data in the evaluation of a target cell's candidacy for handover. For instance, as shown at reference numeral 702, network device 302 can request resource load data from other NG node 120. This load data can be indicative of the overall resource load or indicative of component loads, such as a load of one or more CUs 704 or one or more DUs 706. As non-limiting examples, resource load data can relate, for instance, to a processing load, a transport network layer (TNL) load, a physical resource block (PRB) load or usage, a number of connected users, a number of inactive users, and so on.

In some embodiments, request 702 can be delivered via Xn interface 222. In some embodiments, in response to request 702, the resource load data can be received via Xn interface 222, as illustrated at reference numeral 708. Such resource load data can be received for each handover candidate that is to be evaluated for target selection. Thus, resource load data can be received from multiple other NG nodes 120 and can be broken out for each DU 706 or cell of a given other NG node 120. From this information, network device 302 can determine neighbor load score 506, as indicated at reference numeral 710.

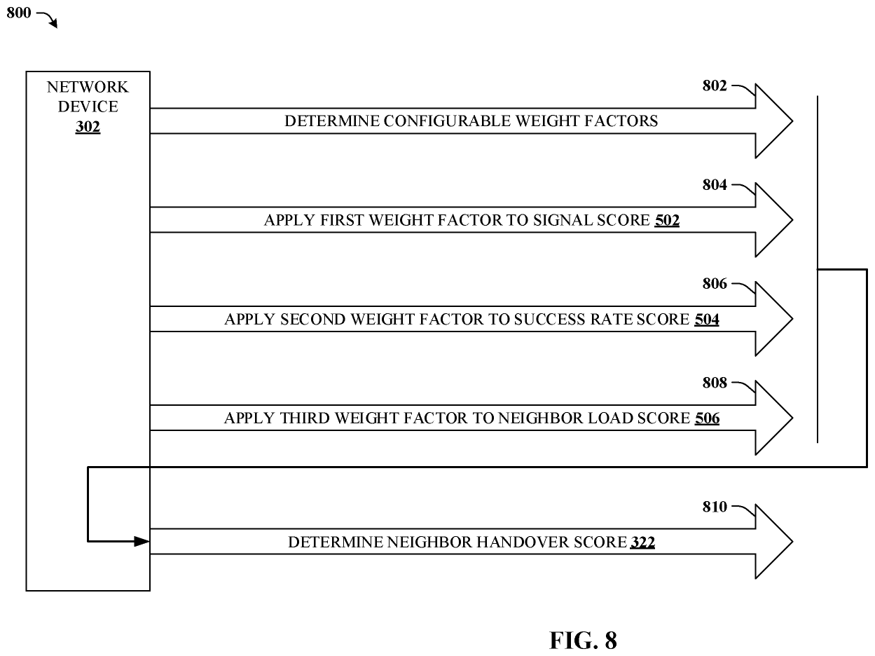

Turning now to FIG. 8, a schematic block diagram 800 is depicted illustrating techniques for determining neighbor handover score 322 in accordance with some example embodiments of this disclosure. As mentioned, neighbor handover score 322 can be determined as a combination of multiple different scores such as any combination of all or a portion of signal score 502, success rate score 504, neighbor load score 506, and so forth. Each of these scores, 502, 504, 506, can be evaluated and can contribute to the final handover score 322 for a particular target cell.

In addition, in some embodiments, scores 502, 504, 506 can be weighted by respective, configurable weight factors. These weight factors can be determined based on operator experience, based on a particular implementation or policy, based on machine learning techniques, or other techniques or data.

As illustrated at reference numeral 802, network device can determine configurable weight factors, e.g., one for each of the multiple scores being evaluated and/or combined. At reference numeral 804, network device 302 can apply a first weight factor to signal score 502. At reference numeral 806, network device 302 can apply a second weight factor to success rate score 504. At reference numeral 808, network device 302 can apply a third weight factor to neighbor load score 506.

A concrete example is illustrated in connection with Table II shown below:

TABLE II

| | Apply Weight | Handover Score |
|---|---|---|
| | Factors | (HS) |
| Signal score (S): | (S)*(0.75) | (S)*(0.75) + |
| Success Rate Score (SR): | (SR)*(0.15) | (SR)*(0.15) + |
| Neighbor Load Score (NL): | (NR)*(0.10) | (NR)*(0.10) = HS |

In this example, signal score 502 (denoted S in Table II) is given the most weight, allowing this score to contribute 75% weight to the final handover score 322. Therefore, it is expected that the highest handover score 322 (denoted HS in Table II) will belong to a target cell that has good signal measurements 308, e.g., measured to have good quality, good strength, etc. according to a defined signal quality metric, a defined strength metric, etc. However, among those candidates with good signal measurements 308 (e.g., potential handover target cell devices 314), the remaining scores can distinguish with a higher probability of success and/or a better user experience than relying essentially on signal measurements alone.

Success rate score 504 (denoted SR in Table II) is, in this example given a 15% weight factor. Neighbor load score 506 (denoted NR in Table II) is given a 10% weight factor. Based on these quantities, network device 302 can determine neighbor handover score 322. Thereafter, neighbor handover score 322 can be used to select handover target 328 such as the particular cell having the highest (or otherwise best) neighbor handover score 322.

### Example Methods

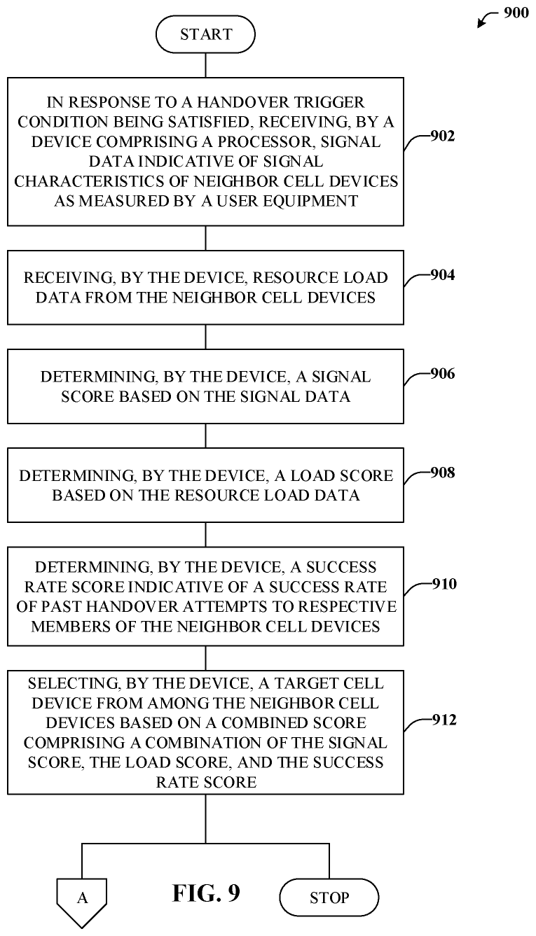

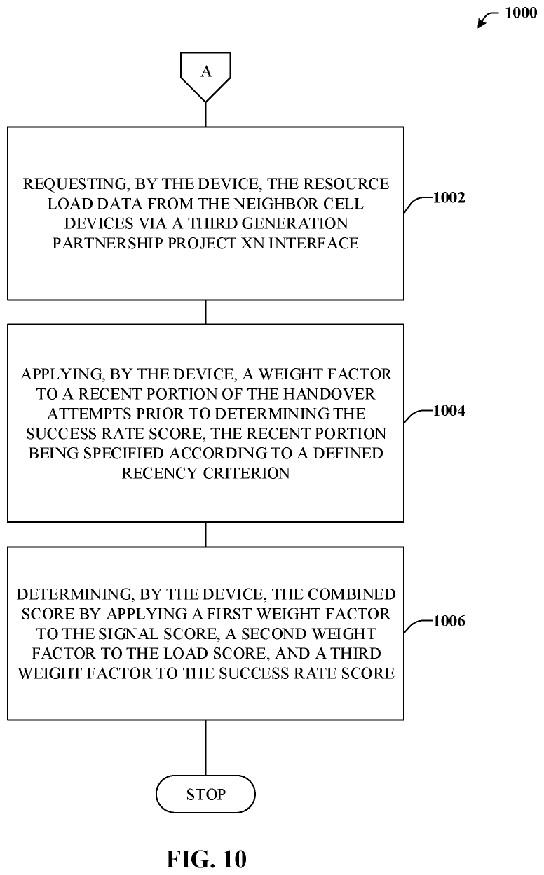

FIGS. 9 and 10 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Referring now to FIG. 9, exemplary method 900 is depicted. Method 900 can select a handover target cell based on a neighbor load score and/or a historic handover success rate score in accordance with some example embodiments of this disclosure. While method 900 describes a complete method, in some embodiments, method 900 can include one or more elements of method 1000, as illustrated by insert A.

At reference numeral 902, a device comprising a processor can receive signal data. The signal data can be indicative of signal characteristics of neighbor cell devices as measured by a user equipment. Measurement of the signal characteristics of the neighbor cell devices, and subsequent reporting of the same to the device can be as a result of a handover trigger condition being satisfied.

At reference numeral 904, the device can receive resource load data from the neighbor cell devices. In some embodiments, this resource load data can be received from only a subset of the neighbor cell devices, such as those that have sufficient signal quality metrics as measured by the user equipment and reported as part of the signal data.

At reference numeral 906, the device can determine a signal score based on the signal data. In some embodiments, an individual signal score can be determined for all or a portion of the neighbor cell devices and/or cell devices that are candidates for handover cell selection.

At reference numeral 908, the device can determine a load score based on the resource load data. The resource load data can be indicative of some relevant usage or load for a neighbor device that, if high, can negatively impact the changes of success of a handover to that neighbor device.

At reference numeral 910, the device can determine a success rate score. The success rate score can be indicative of a success rate of past handover attempts to respective members of the neighbor cell devices. In some embodiments, the success rate score can be determined by applying a weight metric to the success rate of recent handovers that occurred after a defined time and applying the same or a different weight metric to the success rate of older handovers that occurred before the defined time. The success rate score can thus be a combination of these two configurable, weight metrics applied to the appropriate group.

At reference numeral 912, the device can select a target cell device from among the neighbor cell devices based on a combined score comprising a combination of the signal score, the load score, and the success rate score. Method 900 can terminate or continue to insert A, which is further detailed in connection with FIG. 10.

Turning now to FIG. 10, exemplary method 1000 is depicted. Method 1000 can provide for additional elements in connection with selecting a handover target cell based on a neighbor load score and/or a historic handover success rate score in accordance with some example embodiments of this disclosure.

At reference numeral 1002, the device introduced at reference numeral 902 comprising a processor can request the resource load data from the neighbor cell device via a third generation partnership project Xn interface. In some embodiments, the resource load data can be transmitted from the neighbor cell device via the Xn interface.

At reference numeral 1004, the device can apply a weight factor to a recent portion of the handover attempts prior to determining the success rate score. The recent portion can be specified according to a defined recency criterion. In some embodiments, the same or a different weight factor can be applied to an older portion of the handover attempts that occurred before the defined recency criterion.

At reference numeral 1006, the device can determine the combined score. The combined score can be determined by applying a first weight factor to the signal score, a second weight factor to the load score, and a third weight factor to the success rate score.

### Example Operating Environments

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In this regard, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated example embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or” and it therefore interchangeable with the term “and/or”. That is, unless specified otherwise, or clear from context, “X employs A or B” (or any like example) is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A network device, comprising:
a processor; and
a memory that stores executable instructions that, when executed by the processor, facilitate performance of operations, comprising:
configuring a user equipment that is served via a serving cell device to report signal data representative of signal measurements comprising respective signal metric values associated with signaling with a group of neighbor cell devices, comprising a neighbor cell device;
in response receiving the signal data from the user equipment, determining, from among the group of neighbor cell devices, potential handover target cell devices, comprising the neighbor cell device, based on a signal metric value, of the respective signal metric values, being determined to be above a defined threshold signal metric value; and
selecting, from among the potential handover target cell devices, the neighbor cell device as a target device for a handover operation from the serving cell device as a result of performing a handover selection procedure, the handover selection procedure comprising:
determining that the neighbor cell device has a handover score that is highest among handover scores of the potential handover target cell devices, wherein the handover score is a combination of multiple scores comprising:
a signal score determined as a function of the signal metric value; and
a success rate score indicative of past success rates of handovers to the neighbor cell device.

2. The network device of claim 1, wherein the network device is a centralized unit control plane device of a disaggregated gNodeB that enables network access for the user equipment.

3. The network device of claim 1, wherein the configuring comprises defining a trigger condition that triggers the signal measurements of the group of neighbor cells by the user equipment, and further triggers reporting of the signal data by the user equipment to the network device.

4. The network device of claim 1, wherein the signal metric value of the respective signal metric values of the signal data comprises at least one value of a group of values comprising: a reference signal received power value of the neighbor cell device, a reference signal received quality value of the neighbor cell device, a signal to interference plus noise ratio value of the neighbor cell device, or a received signal strength indicator value of the neighbor cell device.

5. The network device of claim 1, wherein the success rate score is specific to first ones of the handovers that occurred between the serving cell device and the neighbor cell device.

6. The network device of claim 1, wherein the operations further comprise determining the success rate score as a function of a recent handover success rate relating to first ones of the handovers that occurred after a defined time and an older handover success rate relating to second ones of the handovers that occurred before the defined time, wherein the defined time is configurable.

7. The network device of claim 6, wherein determining the success rate score comprises determining the success rate score as a function of a first weight metric value applied to the recent handover success rate and a second weight metric value applied to the older handover success rate, and wherein the first weight metric value and the second weight metric value are configurable.

8. The network device of claim 1, wherein the multiple scores further comprise a load score indicative of resource load data of a neighbor node device that comprises the neighbor cell device that is determined prior to a handover operation.

9. The network device of claim 8, wherein the operations further comprise requesting the resource load data from the neighbor node device via an Xn interface defined by a third generation partnership project communication protocol.

10. The network device of claim 8, wherein the resource load data comprises at least one member of a group comprising: first data indicative of a processor load, second data indicative of a transport network layer load, third data indicative of physical resource block usage, fourth data indicative of a connected user count, or fifth data indicative of an inactive user count.

11. The network device of claim 8, wherein the resource load data relates to at least one of: a distributed unit of the neighbor node device or a centralized unit control plane device of the neighbor node device.

12. A network device, comprising:
a processor; and
a memory that stores executable instructions that, when executed by the processor, facilitate performance of operations, comprising:
configuring a user equipment that is served by a serving cell device to report signal data representative of signal measurements of signals communicated between the user equipment and neighbor cell devices;
in response receiving the signal data from the user equipment, determining, from among the neighbor cell devices, potential handover target cell devices, based on a respective signal strength value of the signal data being above a defined threshold; and
selecting, from among the potential handover target cell devices, a neighbor cell device as a target of a handover procedure from the serving cell device in response to performing a handover selection procedure, the handover selection procedure comprising:
determining that the neighbor cell device has a handover score that is highest among handover scores of the potential handover target cell devices, wherein the handover score is a combination of multiple scores comprising:
a signal score determined as a function of the signal measurements; and
a load score indicative of resource load data of a neighbor node device that comprises the neighbor cell device, wherein the resource load data is retrieved via a Xn interface defined according to third generation partnership project communication protocol.

13. The network device of claim 12, wherein the multiple scores, comprising the signal score and the load score, further comprise a success rate score indicative of previous success rates of handovers to the neighbor device.

14. The network device of claim 13, wherein the success rate score is specific to handovers between the serving cell device and the neighbor cell device.

15. The network device of claim 13, wherein the operations further comprise determining the handover score in response to applying a first weight factor to the signal score, applying a second weight factor to the load score, and applying a third weight factor to the success rate score.

16. The network device of claim 15, wherein the first weight factor, the second weight factor, and the third weight factor are configurable.

17. A method, comprising:
in response to a handover trigger condition being satisfied, receiving, by a device comprising a processor, signal data indicative of signal characteristics of neighbor cell devices as measured by a user equipment;
receiving, by the device, resource load data from the neighbor cell devices;
determining, by the device, a signal score based on the signal data;
determining, by the device, a load score based on the resource load data;
determining, by the device, a success rate score indicative of a success rate of past handover attempts to respective members of the neighbor cell devices; and
selecting, by the device, a target cell device from among the neighbor cell devices based on a combined score comprising a combination of the signal score, the load score, and the success rate score.

18. The method of claim 17, further comprising requesting, by the device, the resource load data from the neighbor cell device via a third generation partnership project Xn interface.

19. The method of claim 17, further comprising applying, by the device, a weight factor to a recent portion of the handover attempts prior to determining the success rate score, the recent portion being specified according to a defined recency criterion.

20. The method of claim 17, further comprising determining, by the device, the combined score by applying a first weight factor to the signal score, a second weight factor to the load score, and a third weight factor to the success rate score.
